(19) United States
(12) Patent Application Publication
(10) Pub. No.: US 2007/0189607 A1
(43) Pub. Date: Aug. 16, 2007

(54) SYSTEM AND METHOD FOR EFFICIENT FEATURE DIMENSIONALITY AND ORIENTATION ESTIMATION

(75) Inventors: Yunqiang Chen, Plainsboro, NJ (US); Tong Fang, Morganville, NJ (US); Jason Jenn-Kwei Tyan, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH INC, PRINCETON, NJ (US)

(21) Appl. No.: 11/548,714

(22) Filed: Oct. 12, 2006

Related U.S. Application Data
(60) Provisional application No. 60/727,575, filed on Oct. 17, 2005.

(51) Int. Cl. G06K 9/48

(52) U.S. Cl. 382/199

(57) ABSTRACT

A method of automatically detecting features in an image includes: designing a gradient detection filter and a line detection filter; applying the gradient detection filter and line detection filter to detect structures in an image; and estimating feature dimensionality and orientation of the detected structures in the image. The computation cost of gradient detection and line detection when applied on an image is a constant number of operations independent of the size of the gradient and line detection filters.

### CROSS-REFERENCE TO RELATED APPLICATION

This application claims the benefit of U.S. Provisional Application Ser. No. 60/727,575 (Attorney Docket No. 2005P18881US), filed Oct. 17, 2005 and entitled “Efficient Feature Dimensionality and Orientation Estimation Based on Integral Image”, the content of which is herein incorporated by reference in its entirety.

### BACKGROUND OF THE INVENTION

1. Technical Field

The present disclosure relates to signal detection and, more particularly, to systems and methods for efficient feature dimensionality and orientation estimation.

2. Discussion of Related Art

In recent years, medical imaging has experienced an explosive growth due to advances in imaging modalities such as X-rays, computed tomography (CT), magnetic resonance imaging (MRI) and ultrasound. An important step in medical image filtering is the detection of signals. Various filter techniques can be applied, such as steerable filters, wavelets and so on.

In regions that contain no signal, local differences in the intensity are caused by noise, and some kind of smoothing filter is commonly applied to reduce noise. But such smoothing filter could blur the important signal in the image as well. So reliable signal detection is needed in order to obtain a good filtering result. In the case of noisy images, the intensity variations caused by true signal is often in the same range as the intensity variations caused by noise, and a differentiation can only be made when also using a wider view of the image. Doing so often allows identifying large structures much better than focusing on a small neighborhood.

In view of the need for a probabilistic interpretation of the results, an algorithm should estimate the intrinsic dimensionality of the signal, usually zero (such as smooth surface region), one (such as line or edge structures) or two (such as corners), and provide a likelihood number between 0 and 1 which can be interpreted as probabilities instead of a binarized (i.e., true or false) classification result. This means that the numbers have to be in the interval between zero and one and that the numbers have to sum up to one in any case. Examples of algorithms discussed in the literature include: steerable filters to detect and accurately orientate structures; curvelets for image denoising; contourlets to efficiently represent images at different scales and to approximate the most significant structures; and probabilistic approaches to computing intrinsic image dimensionality.

Methods based on Fourier transformation have been used to detect structures. For images with low noise level, such methods may produce accurate results, but are not suitable in the case of very noisy image. Moreover, the computation of the local Fourier spectrum for every pixel is time-consuming, making the computation slow and inefficient.

### SUMMARY OF THE INVENTION

According to an exemplary embodiment of the present invention, a method is provided for providing feature detection in an image. The method includes: designing a gradient detection filter and a line detection filter; applying the gradient detection filter and line detection filter to detect structures in an image; and estimating feature dimensionality and orientation of the detected structures in the image.

According to an exemplary embodiment of the present invention, a system for providing automatic feature detection in an image comprises: a memory device for storing a program; a processor in communication with the memory device, the processor operative with the program to: design a gradient detection filter and a line detection filter; apply the gradient detection filter and line detection filter to detect structures in an image; and estimate feature dimensionality and orientation of the detected structures in the image.

According to an exemplary embodiment of the present invention, a method is provided for providing efficient feature detection. The method includes: calculating an integral image; designing a gradient detector based on the integral image; designing a line detector based on the integral image; applying the gradient detector and line detector at one or more angles and one or more scales to detect a feature along one or more directions; combining the gradient detector and the line detector outputs at one or more angles and one or more scales; classifying the output for each pixel to features or noise regions; and estimating feature dimensionality and orientation.

### BRIEF DESCRIPTION OF THE DRAWINGS

The present invention will become more apparent to those of ordinary skill in the art when descriptions of exemplary embodiments thereof are read with reference to the accompanying drawings.

FIG. 1 is a flowchart showing a method of automatically detecting features in an image, according to an exemplary embodiment of the present invention.

FIG. 2 illustrates a computer system for implementing a method of automatic feature detection, according to an exemplary embodiment of the present invention.

FIG. 3 is a flowchart showing a method of automatically detecting features in an image, according to an exemplary embodiment of the present invention.

### DESCRIPTION OF EXEMPLARY EMBODIMENTS

Hereinafter, the exemplary embodiments of the present invention will be described in detail with reference to the accompanying drawings.

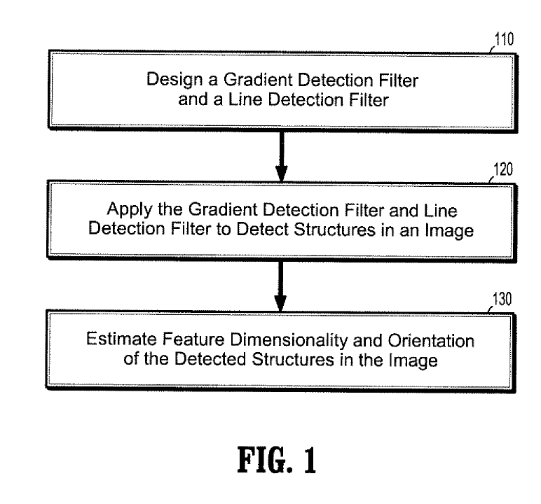

FIG. 1 is a flowchart showing a method of automatically detecting features in an image, according to an exemplary embodiment of the present invention. Two types of filters may be used to detect features in the image: a gradient detection filter and a line detection filter.

Referring to FIG. 1, in step 110, design a gradient detection filter and a line detection filter. Gradient detection and line detection may be based on a constant number of additions per pixel or a constant number of subtractions per pixel. In an exemplary embodiment of the present invention, gradient detection and line detection are based on integral images. For example, the use of integral images may allow the computation of any gradient or line detection with a small, constant number of additions/subtractions per pixel and can greatly speed up the computation when a large neighborhood is used in the detection for accuracy and robustness.

For example, to compute the derivative of a two-dimensional image, the gradient may be used. It may comprise summing the pixel intensities in two separate regions together and taking the difference of these sums.

With regard to the size of the gradient detection filter, there is a tradeoff between the detectability of small structures, which favors small filters, and the robustness to noise, which favors large filters. In an exemplary embodiment of the present invention, the size of the gradient detection filter depends on the image type or noise level of the image

The ratio between length and width of the gradient detection filter may determine a sensitivity of detecting structures that are not parallel to an orientation of the gradient detection filter. In an exemplary embodiment of the present invention, the line detection filter comprises a middle strip, where the pixels are summed together, and two side strips, where the pixels are equally summed up together. The filter response may consist of the difference of the two sums.

The width of each of the side strips may be about one-half the width of the middle strip. As the size of the line detection filter, there is the tradeoff between the detection of small structures and the robustness to noise. The ratio between length and width of the middle strip may determine sensitivity to angular differences between an orientation of the line detection filter and the direction of a line. The two side strips may be of substantially equal size. In an exemplary embodiment of the present invention, when the area of the middle strip is not the same as the area of one of the two side strips, a weighting factor is used. The actual size of the different part of the filters may be chosen such that the total number of covered pixels is the same. In an exemplary embodiment of the present invention, three different sizes of gradient detection and line detection filters are used to identify structures of different magnitudes in the image. The scaling factor may be about 2 or about 4. It is to be understood that various scaling factors can be employed.

In step 120, apply the gradient detection filter and line detection filter to detect structures in an image. The gradient detection and line detection filters may be applied at one or more angles and one or more scales to detect a feature along one or more directions. The gradient detection and line detection filters both may be applied at four different angles with respect to the x-axis. For example, the four angles may be 0 degrees, 45 degrees, 90 degrees and 135 degrees with respect to the x-axis. The orientation vectors of the gradient detection and line detection filters may be given by Equation 1.

$$\vec{{n}_{1}} = ( \begin{matrix}1 \\ 0\end{matrix} ) , \\ \vec{{n}_{2}} = ( \begin{matrix}1 / \sqrt{2} \\ 1 / \sqrt{2}\end{matrix} ) , \\ \vec{{n}_{3}} = ( \begin{matrix}0 \\ 1\end{matrix} ) \\ and \\ \vec{{n}_{4}} = ( \begin{matrix}- 1 / \sqrt{2} \\ 1 / \sqrt{2}\end{matrix} ) \qquad ( 1 )$$

In an exemplary embodiment of the present invention, only the absolute values of the responses are used, and the given directions correspond to an equal distribution over all orientations. A computation cost of gradient detection and line detection when applied on an image may be a constant number of operations independent of a size of the gradient detection filter and a size of the line detection filter. Building the integral image may comprise 3 or 5 operations. Using the integral image may comprise 3 or 5 operations for each angle and each scale.

In step 130, estimate feature dimensionality and orientation of the detected structures in the image. For example, compute combined feedback values and an edge probability in each direction, wherein the combined feedback values are based on results of applying the gradient detection and line detection filters. The combined feedback value may be computed based on results of applying the gradient detection and line detection filters in three different sizes and in four orientations. To give more weight to the large values, which are more likely to be signal than noise, the root square mean may be used for averaging. For combining the results from different detection scales, a value approaching a geometric mean may be used to average the combined feedback values of the different scales. The total filter response rᵢ in every direction can be chosen based on the formula expressed in Equation 2.

$${r}_{i} = \sqrt{\sqrt{\frac{{}_{}^{s}{q}{}_{i}^{2} + {}_{}^{s}{l}{}_{i}^{2}}{2}} \cdot \sqrt{\frac{{}_{}^{m}{q}{}_{i}^{2} + {}_{}^{m}{l}{}_{i}^{2}}{2}} \cdot \sqrt{\frac{{}_{}^{b}{q}{}_{i}^{2} + {}_{}^{b}{l}{}_{i}^{2}}{2}}} , \qquad ( 2 )$$

where ^{s}qᵢ and ^{s}lᵢ indicate the response of the small gradient and line detectors, respectively, ^{m}qᵢ and ^{m}lᵢ the responses of the medium sized detectors and ^{b}qᵢ and ^{b}ᵢ the responses of the big detectors.

The noise level may depend on the source of the image. An estimated noise variance can be used to anticipate the probability that a given detection response originates from noise. For example, to estimate the noise level of the image, the standard deviation of the local neighborhood may be computed for every pixel and averaged. In order not to be falsified by homogeneous regions, which would lead to a overly small estimation result, or by true structures, which would lead to a overly high estimation, only pixels where the local variation lies within an interval may be used for the averaging process. The lower bound of the interval may be a constant that prevents homogeneous regions without variation to lower the result. As upper threshold, take the maximal value at the beginning and then do several iterations, where the upper interval bound may be given by the double of the estimated variation value from the previous round. The estimation for the variance may converge quite fast, such as for example, after two or three iterations. For example, after two or three iterations, the estimated value may change less than one percent.

Using the above-described response value and the estimated noise level of the image, an edge probability may be computed for every direction at every pixel position. For example, assume the probability for being a structure to be constant for every value of rᵢ. The noise distribution is found to be closest to a Rayleigh distribution, which is given by the density function:

$${P}^{Ray} ( r ) = \frac{r {ⅇ}^{- {r}^{2} / 2 {s}^{2}}}{{s}^{2}} , \qquad ( 3 )$$

where s is the parameter of the distribution.

For the estimation of the edge probability, the function described by Equation 4,below, can be used.

$${p}_{i}^{E} = {P}^{Edge} ( {r}_{i} ) = \frac{1}{1 + {P}^{Noise} ( {r}_{i} )} = \frac{1}{1 + {P}^{{Ray}^{*}} ( {r}_{i} )} \qquad ( 4 )$$

For example, a modified version of the Rayleigh distribution may be used that keeps its maximal probability for values of r smaller than the position of the maximum in the original value. Basic calculus yields the condition r =s for the maximum, and thus for the distribution:

$${P}^{{Ray}^{*}} ( {r}_{i} ) = \{ \begin{matrix}\frac{1}{s \sqrt{e}} & {r}_{i} \leq s \\ \frac{{r}_{i} {ⅇ}^{- {{r}_{i}}^{2} / 2 {s}^{2}}}{{s}^{2}} & {r}_{i} \geq s\end{matrix} \qquad ( 5 )$$

Using this remapping function, high edge probabilities are attributed to pixels where the total filter response rᵢ is higher than two or three times the parameter s, whereas the other pixels get a small edge probability This remapping is done separately for every direction, in order to prevent noise to sum up to higher values that can be similar to a response value for a tiny line in a given direction.

Given the edge probabilities in the four directions, an approximation of the structure tensor may be done, which may serve as basis for the estimation of the probabilities for the three dimensionalities and for the direction. Based on the probabilities in the four directions, the three moments of second degree can be approximated as follows:

$${μ}_{20} = {\sum }_{i} {n}_{i , x}^{2} {p}_{i}^{E} = {p}_{0}^{E} + \frac{{p}_{1}^{E}}{2} + \frac{{p}_{3}^{E}}{2} \\ {μ}_{02} = {\sum }_{i} {n}_{i , y}^{2} {p}_{i}^{E} = \frac{{p}_{1}^{E}}{2} + {p}_{2}^{E} + \frac{{p}_{3}^{E}}{2} \\ {μ}_{11} = {\sum }_{i} {n}_{i , x} {n}_{i , y} {p}_{i}^{E} = \frac{{p}_{1}^{E}}{2} - \frac{{p}_{3}^{E}}{2} \qquad ( 6 )$$

The structure tensor may be composed as follows:

$$T = ( \begin{matrix}{μ}_{20} & {μ}_{11} \\ {μ}_{11} & {μ}_{02}\end{matrix} ) . \qquad ( 7 )$$

Given the tensor composed of the mentioned moments, the shape and orientation of the ellipse can be estimated using the eigenvalue decomposition: The first eigenvalue λ₁ gives the length of the major axis, the first eigenvector \vec{e₁} its direction. The second eigenvalue λ₂ gives the length of the minor axis and the corresponding eigenvector \vec{e₂} its orientation, which is orthogonal to \vec{e₁}. The energy is given by Equation 8,
E=\sqrt{λ₁²+λ₂²} (8)
and is used as a measure for the probability of signal:

$$\begin{matrix}{P}_{signal} = \frac{\sqrt{{λ}_{1}^{2} + {λ}_{2}^{2}}}{\sqrt{8}} \\ and & ( 9 ) \\ {P}_{noise} = 1 - {P}_{signal} = 1 - \frac{\sqrt{{λ}_{1}^{2} + {λ}_{2}^{2}}}{\sqrt{8}} & ( 10 )\end{matrix}$$

Normalizing the energy, a probability for signal is obtained. Furthermore, if the first eigenvalue is large and the second one small, the structure has a high probability to be of dimension one. If both eigenvalues are large, the structure will is likely to be two-dimensional. From these observations, the following expressions are obtained to estimate the probability for the different dimensionalities:

$$\begin{matrix}{P}_{0 D} = {P}_{noise} & ( 11 ) \\ {P}_{1 D} = {P}_{signal} \cdot \frac{{λ}_{1} - {λ}_{2}}{{λ}_{1} + {λ}_{2}} & ( 12 ) \\ {P}_{2 D} = {P}_{signal} \cdot \frac{2 {λ}_{2}}{{λ}_{1} + {λ}_{2}} & ( 13 )\end{matrix}$$

The three values are in the interval [0;1] and sum up to 1 for any tensor.

Apart from detecting signal parts, finding the orientation of the structures can be a useful feature, as filtering is mostly done along lines and edges once they are detected. The angle may be estimated. As described above, the first eigenvector \vec{e₁}=(e_{1,x}e_{1,y})^{T} points into the direction of the major axe and thus contains the angular information. It can be computed as:

$$θ = {tan}^{- 1} ( \frac{{e}_{1 , y}}{{e}_{1 , x}} ) \qquad ( 14 )$$

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

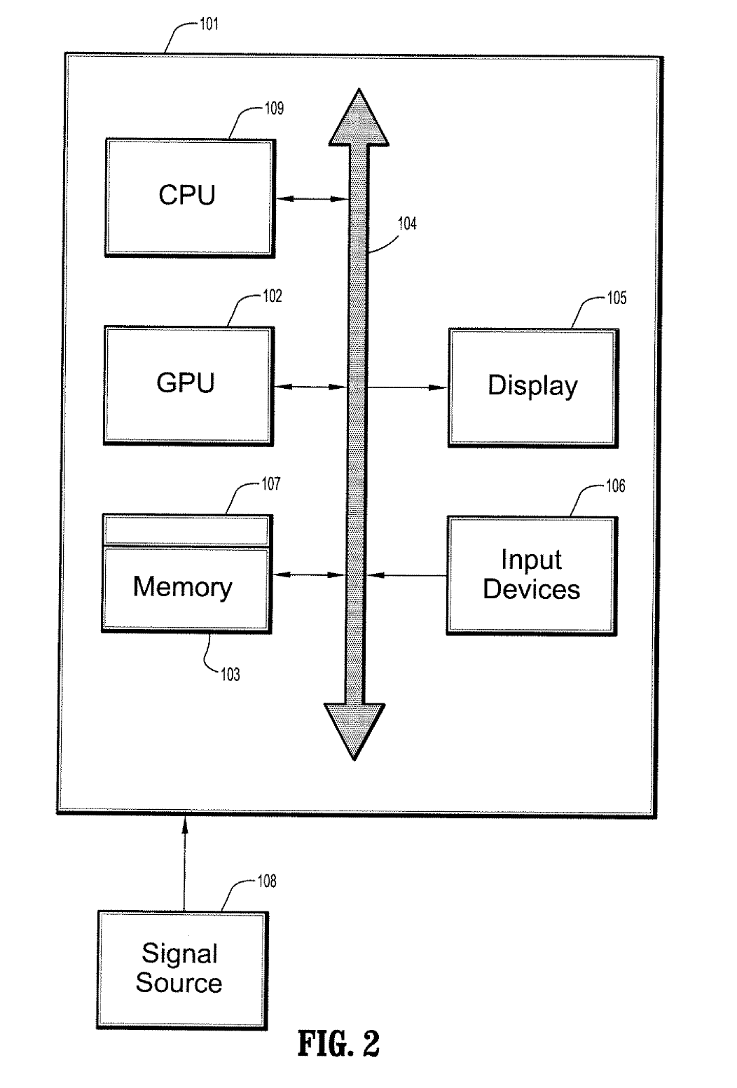

Referring to FIG. 2, according to an embodiment of the present disclosure, a computer system 101 for implementing a method of automatic feature detection can comprise, inter alia, a central processing unit (CPU) 109, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 109 to process the signal from the signal source 108. As such, the computer system 101 is a general purpose computer system that becomes a specific purpose computer system when executing the routine 107 of the present invention. The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

In an exemplary embodiment of the present invention, a system for providing automatic feature detection in an image comprises a memory device 103 for storing a program, and a processor 109 in communication with the memory device 103. The processor 109 is operative with the program to: design a gradient detection filter and a line detection filter; apply the gradient detection filter and line detection filter to detect structures in an image; and estimate feature dimensionality and orientation of the detected structures in the image.

The processor 109 may be further operative with the program to compute combined feedback values and an edge probability in each direction, wherein the combined feedback values are based on results of applying the gradient detection and line detection filters.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

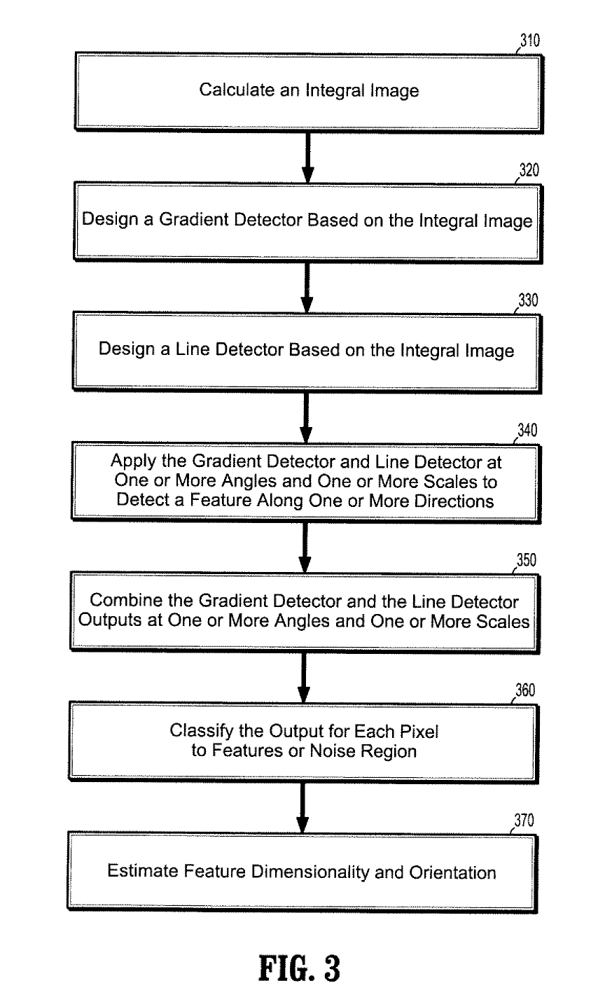

FIG. 3 is a flowchart showing a method of automatically detecting features in an image, according to an exemplary embodiment of the present invention. Referring to FIG. 3, in step 310, calculate an integral image. In step 320, design a gradient detector based on the integral image. In step 330, design a line detector based on the integral image.

In step 340, apply the gradient detector and line detector at one or more angles and one or more scales to detect a feature along one or more directions. The gradient detection and line detection filters both may be applied at four different angles with respect to the x-axis. For example, the four angles may be 0 degrees, 45 degrees, 90 degrees and 135 degrees with respect to the x-axis.

In step 350, combine the gradient detector and the line detector outputs at one or more angles and one or more scales. In step 360, classify the output for each pixel to features or noise region. In step 370, estimate feature dimensionality and orientation.

A computation cost of gradient detection and line detection when applied on an image may be a constant number of operations independent of a size of the gradient detection filter and a size of the line detection filter. Building the integral image may comprise 3 or 5 operations. Using the integral image may comprise 3 or 5 operations for each angle and each scale.

Although the processes and apparatus of the present invention have been described in detail with reference to the accompanying drawings for the purpose of illustration, it is to be understood that the inventive processes and apparatus are not to be construed as limited thereby. It will be readily apparent to those of reasonable skill in the art that various modifications to the foregoing exemplary embodiments may be made without departing from the spirit and scope of the invention as defined by the appended claims.

What is claimed is:

1. A method of automatically detecting features in an image, comprising:
designing a gradient detection filter and a line detection filter;
applying the gradient detection filter and line detection filter to detect structures in an image; and
estimating feature dimensionality and orientation of the detected structures in the image.

2. The method of claim 1, wherein gradient detection and line detection are based on a constant number of additions per pixel or a constant number of subtractions per pixel.

3. The method of claim 2, wherein gradient detection and line detection are based on integral images.

4. The method of claim 3, wherein a computation cost of gradient detection and line detection when applied on an image is a constant number of operations independent of a size of the gradient detection filter and a size of the line detection filter.

5. The method of claim 4, wherein building the integral image comprises 3 or 5 operations.

6. The method of claim 5, wherein using the integral image comprises 3 or 5 operations for each angle and each scale.

7. The method of claim 1, wherein a size of the gradient detection filter depends on image type or noise level of the image.

8. The method of claim 1, wherein a ratio between a length and a width of the gradient detection filter determines a sensitivity of detecting structures that are not parallel to an orientation of the gradient detection filter.

9. The method of claim 1, wherein the line detection filter comprises a middle strip and two side strips.

10. The method of claim 9, wherein a width of each of the side strips is about one-half a width of the middle strip.

11. The method of claim 10, wherein a ratio between a length and a width of the middle strip determines sensitivity to angular differences between an orientation of the line detection filter and the direction of a line.

12. The method of claim 9, wherein the two side strips are of a substantially equal size, and wherein when an area of the middle strip is not the same as an area of one of the two side strips, a weighting factor is used.

13. The method of claim 1, wherein the gradient detection and line detection filters are applied at one or more angles and one or more scales to detect a feature along one or more directions.

14. The method of claim 13, wherein the gradient detection and line detection filters are applied at four different angles with respect to the x-axis.

15. The method of claim 14, wherein the four angles are 0 degrees, 45 degrees, 90 degrees and 135 degrees with respect to the x-axis.

16. The method of claim 13, wherein a scaling factor is about 2 or about 4.

17. The method of claim 1, further comprising computing combined feedback values and an edge probability in each direction, wherein the combined feedback values are based on results of applying the gradient detection and line detection filters.

18. The method of claim 17, wherein the combined feedback values are based on results of applying the gradient detection and line detection filters in three different sizes and in four orientations.

19. The method of claim 18, wherein a value approaching a geometric mean is used to average the combined feedback values of the different scales.

20. A system for providing automatic feature detection in an image, comprising:
a memory device for storing a program;
a processor in communication with the memory device, the processor operative with the program to:
design a gradient detection filter and a line detection filter;
apply the gradient detection filter and line detection filter to detect structures in an image; and
estimate feature dimensionality and orientation of the detected structures in the image.

21. The system of claim 20, wherein the processor is further operative with the program to compute combined feedback values and an edge probability in each direction, wherein the combined feedback values are based on results of applying the gradient detection and line detection filters.

22. A method of automatically detecting features in an image, comprising:
calculating an integral image;
designing a gradient detector based on the integral image;
designing a line detector based on the integral image;
applying the gradient detector and line detector at one or more angles and one or more scales to detect a feature along one or more directions;
combining the gradient detector and the line detector outputs at one or more angles and one or more scales;
classifying the output for each pixel to features or noise regions; and
estimating feature dimensionality and orientation.

23. The method of claim 22, wherein a computation cost of gradient detection and line detection when applied on an image is a constant number of operations independent of a size of the gradient detection filter and a size of the line detection filter.

24. The method of claim 23, wherein building the integral image comprises 3 or 5 operations.

25. The method of claim 24, wherein using the integral image comprises 3 or 5 operations for each angle and each scale.
